(19) United States
(12) Patent Application Publication
(10) Pub. No.: US 2017/0068217 A1
(43) Pub. Date: Mar. 9, 2017

(54) ANALOGUE SMART WATCH AND DISPLAY METHOD THEREOF

(71) Applicant: EVERDISPLAY OPTRONICS (SHANGHAI) LIMITED, SHANGHAI CITY (CN)

(72) Inventors: Jr-Hong CHEN, Shanghai City (CN); Chien-Er HUANG, Shanghai City (CN)

(73) Assignee: EVERDISPLAY OPTRONICS (SHANGHAI) LIMITED, SHANGHAI CITY (CN)

(21) Appl. No.: 15/069,034

(22) Filed: Mar. 14, 2016

(30) Foreign Application Priority Data
Sep. 8, 2015 (CN) 201510567567.1

(51) Int. Cl. G04B 19/04; G04G 9/00

(52) U.S. Cl. CPC G04B 19/04; G04G 9/0064

(57) ABSTRACT

A pointer-type smart watch and a display method thereof are provided. The pointer-type smart watch includes: a cover, including a touch sensing unit; a case, collectively forming an inner cavity with the cover, and hour and minute hands being rotatable inside the inner cavity; a movement layer, provided at the bottom of the case, connected to the hour and minute hands with a rotation axis to provide power for rotation; a transparent display element, provided in the inner cavity and above the movement layer, and including an axis hole through which the rotation axis passes; a control module, configured to control operating states of the transparent display element; and a transparent solar element, provided in the inner cavity and above the movement layer, and coupled to a battery of the pointer-type smart watch.

This application is based upon and claims priority to Chinese Patent Application No. 201510567567.1, filed on Sep. 8, 2015, the entire contents of which are incorporated herein by reference.

### TECHNICAL FIELD

The present disclosure relates to a watch, particularly to an analogue smart watch (also referred to as a pointer-type smart watch) having touch control display function and a display method thereof.

### BACKGROUND

A smart watch is a wrist watch employed with an embedded system for enhanced functions based on time reporting, and has functions similar to a personal digital assistant (PDA). An early stage smart watch is able to perform base functions of calculating, translating or consoling handheld electronic games, and a mid-term smart watch has realized a function of a wearable computer. Most smart watches are able to execute mobile software applications, some of them may run a mobile operation system (OS), and a few of them have full mobile phone functions. Other functions mainly relate to portable multimedia play, such as playing FM radio and message or movie files and listening through Bluetooth earphones.

Although the smart watch provides a fashion of functionality different from a typical watch, however, the value provided by the manufacturing process of the movement of the typical watch (e.g., a mechanical watch) is irreplaceable by the smart watch. Accordingly, requirements of most customers may be satisfied if the advantages of the typical watch and the smart watch may be combined.

### SUMMARY

According to one aspect of the present disclosure, an analogue smart watch is provided, including: a cover, including a touch sensing unit; a case, collectively forming an inner cavity with the cover, and an hour hand and a minute hand being rotatable inside the inner cavity; a movement layer, provided at the bottom of the case, connected to the hour hand and the minute hand with a rotation axis to provide power for rotation of the hour hand and the minute hand in the inner cavity; a transparent display element, provided in the inner cavity and above the movement layer, wherein the transparent display element includes an axis hole, and the rotation axis passes through the axis hole; a control module, configured to control operating states of the transparent display element; and a transparent solar element, provided in the inner cavity and above the movement layer, and coupled to a battery of the analogue smart watch.

Preferably, the operating states of the transparent display element include a display state and a transparent state, and when the transparent display element is in the transparent state, the movement layer is visible through the cover and the transparent display element.

Preferably, when the transparent display element is in the transparent state, the transparent display element has a transmittance equal to or greater than 90%.

Preferably, the transparent display element is a liquid crystal display device or an organic electroluminescence display device.

Preferably, the control module is provided in the movement layer.

Preferably, the control module is provided outside the inner cavity.

Preferably, the analogue smart watch further includes a physical button, configured to trigger the control module to control the operating states of the transparent display element.

Preferably, the physical button is a crown.

Preferably, the transparent solar element is provided at one of the following positions: between the transparent display element and the movement layer, on the upper surface of the transparent display device, on the lower surface of the cover, and on the upper surface of the cover.

Preferably, the analogue smart watch further includes a display region adjusting module configured to take portions of the transparent display element that are not shielded by the hour hand and the minute hand as at least one display region, according to positions of the hour hand and the minute hand.

Preferably, the positions of the hour hand and the minute hand partition the transparent display element into a first display region corresponding to a first angle between the hour hand and the minute hand and a second display region corresponding to a second angle between the hour hand and the minute hand, wherein the first angle is equal to or greater than the second angle.

Preferably, each of the case, the first display region and the second display region has one of circular shape, triangular shape, rhombus shape, hexagonal shape or rectangular shape.

Preferably, portions of the cover over the display region and corresponding to the display region perform touch sensing and other portions of the cover terminate touch sensing.

According to another aspect of the present disclosure, further provided is a method for displaying of a pointer-type smart watch having a movement layer, a transparent display element, a control module and a transparent solar element collectively configured inside a cavity of a case with a cover, the method comprising: switching operation states of the pointer-type smart watch between a display state and a transparent state; wherein when the pointer-type smart watch is switched to the transparent state, the movement layer of the pointer-type smart watch is visible through the cover and the transparent display element.

Preferably, when the pointer-type smart watch is in the transparent state, the transparent display element has a transmittance equal to or greater than 90%.

Preferably, when the pointer-type smart watch is in the display state, taking portions of the transparent display element that are not shielded by an hour hand and a minute hand of the pointer-type smart watch as at least one display region, according to positions of the hour hand and the minute hand.

Preferably, the positions of the hour hand and the minute hand partition the transparent display element into a first display region corresponding to a first angle between the hour hand and the minute hand and a second display region corresponding to a second angle between the hour hand and the minute hand, wherein the first angle is equal to or greater than the second angle.

Preferably, a center of the first display region is positioned along the bisector of the first angle, and a center of the second display region is positioned along the bisector of the second angle.

Preferably, when the first display region and the second display region are configured as a circular shape, both a diameter of the first display region and a diameter of the second display region are equal to or smaller than the distance from the axis hole to an inner wall of the case.

Preferably, when the first display region and the second display region are configured as a rectangular shape, both a diagonal of the first display region and a diagonal of the second display region are equal to or smaller than the distance from the axis hole to an inner wall of the case.

Preferably, the method further comprising: comparing areas of the first display region and the second display region, and displaying region having a larger area and maintaining the display region having a smaller area the transparent state.

Preferably, the method further comprising: performing touch sensing on portions of the cover over the display region and corresponding to the display region and terminating touch sensing on other portions of the cover.

Preferably, the method further comprising: triggering the control module to control the transparent display element switch between the transparent state and the display state by operating a crown of the analogue smart watch.

### BRIEF DESCRIPTION OF THE DRAWINGS

Other features, purposes and advantages of the present disclosure will become more apparent by reading the detailed description of the non-limiting embodiments with reference to the following drawings, wherein:

FIG. 1 is a section view of a display device in the prior art;

FIG. 2 is a section view of a first analogue smart watch of the present disclosure;

FIG. 3 is a section view of a second analogue smart watch of the present disclosure;

FIG. 4 is a section view of a third analogue smart watch of the present disclosure;

FIG. 5 is a section view of a fourth analogue smart watch of the present disclosure;

FIG. 6 is a schematic diagram illustrating a display effect of the analogue smart watch according to the first embodiment of the present disclosure;

FIG. 7 is a schematic diagram illustrating a display effect of the analogue smart watch according to the first embodiment of the present disclosure;

FIG. 8 is a schematic diagram illustrating a display effect of the analogue smart watch according to the first embodiment of the present disclosure;

FIG. 9 is a schematic diagram illustrating an analogue smart watch partitioned into a first display region and a second display region according to the second embodiment of the present disclosure;

FIG. 10 is a schematic diagram illustrating an analogue smart watch partitioned into a first display region and a second display region according to the second embodiment of the present disclosure;

FIG. 11 is a schematic diagram illustrating a display effect in which two display regions of the analogue smart watch are simultaneously displayed according to the second embodiment of the present disclosure;

FIG. 12 is a schematic diagram illustrating an optimized display region of an analogue smart watch according to the third embodiment of the present disclosure;

FIG. 13 is a schematic diagram illustrating an optimized display effect of the analogue smart watch according to the third embodiment of the present disclosure;

FIG. 14 is a schematic diagram illustrating an optimized display effect of the analogue smart watch according to the third embodiment of the present disclosure; and

FIG. 15 is a schematic diagram illustrating an optimized display effect of the analogue smart watch according to the third embodiment of the present disclosure.

### DETAILED DESCRIPTION

The example embodiments will now be described more fully with reference to the accompanying drawings. However, the example embodiments cam be implemented in various forms, and should not be interpreted as being limited to the embodiments set forth herein; on the contrary, these embodiments are provided such that the present disclosure will be thorough and complete, and will fully convey the concept of the example embodiments to those skilled in the art. In the drawings, the same reference numerals denote the same or like structures, and thus their repeated description will be omitted.

The described features, structures or characters may be combined in one or more embodiments in any suitable manner. In the following description, numerous specific details are provided so as to allow a full understanding of the embodiments of the present disclosure. However, those skilled in the art will recognize that the technical solutions of the present disclosure may be implemented without one or more of the specific details, or other methods, components, materials and so on may be used. In other cases, the well-known structures, materials or operations are not shown or described in detail to avoid obscuring various aspects of the present disclosure.

### The First Embodiment

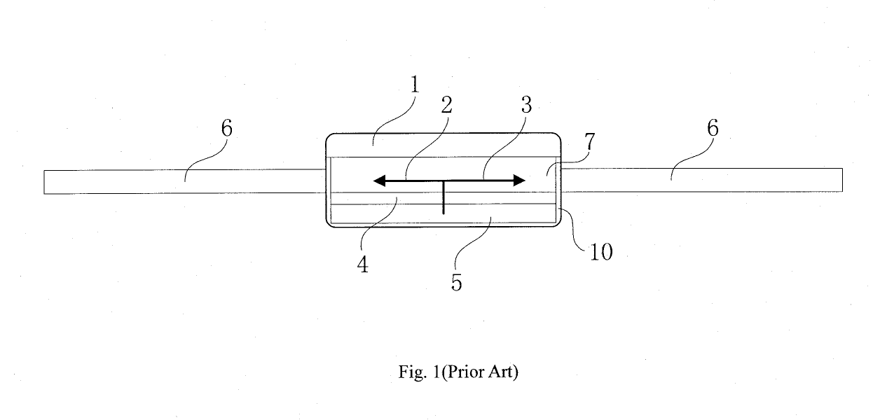

As illustrated in FIG. 1, the first embodiment of the present disclosure provides an analogue smart watch including: a cover 1, a case 10, a band 6, a crown 9, a transparent display element 4, a control module and a transparent solar element 8. The cover 1 has a touch sensing unit. In the present embodiment, the cover 1 may include a glass watch cover and a transparent thin film capacitor array provided under the glass watch cover, that is, the thin film capacitor array is used as the touch sensing unit. The thin film capacitor array detects a touch action of the user on the surface of the glass cover and transmits the same to the control module. The case 10 and the cover collectively form an inner cavity 7, and the hour hand 2 and the minute hand 3 rotate inside the inner cavity 7. A movement layer 5 is provided at the bottom of the case 10, and the movement layer 5 is connected to the hour hand and the minute hand to provide power for the rotation of the hour and minute hands in the inner cavity. The band 6 is connected to the opposite ends of the case 10. The transparent display element 4 is provided in the inner cavity 7 and above the movement layer 5. The transparent display element 4 includes an axis hole, and the rotation axis of the hour hand 2 and the minute hand 3 passes through the axis hole. Preferably, the transparent display element 4 has the same shape and area as those of the cover 1, and the transparent display element 4 and the cover 1 have great control accuracy with each other. Accordingly, even though the cover 1 is positioned at a different height level from the transparent display element 4, i.e., they are spaced apart by the parts like the hour hand 2, the minute hand 3 and so on, the user may feel like he is performing touch control operating directly on the transparent display element 4. The crown 9 is configured as a trigger control module, and the control module is configured to control the operating states of the transparent display element 4.

The transparent display element 4 mainly includes two operating states: a display state in which an image is displayed and a transparent state in which no image is displayed. When the transparent display element 4 is in the transparent state, the transparent display element 4 has a transmittance equal to or greater than 90%. The movement layer 5 is visible through the cover 1 and the transparent display element 4, and the user may see the beautiful movement layer 5. At this time, the analogue smart watch of the present disclosure has the same visual effect as the conversional mechanical watch. Obviously, in the present embodiment, the crown 9 may control the switch of the transparent display element 4 between the display state in which an image is displayed and the transparent state in which no image is displayed. The control module may be further provided with smart functions such as providing time, short message, internet access, GPRS and so on.

The transparent display element 4 is a liquid crystal display device (LCD) or an organic electroluminescence display device (or an organic light emitting display device, OLED). The user may perform touch operation on the cover 1 like using a touch-type smart watch, and see the fed back content on the transparent display element 4, while also see the beautiful movement layer 5. At this time, the analogue smart watch of the present disclosure has the visual effect having both the characters of the analogue smart watch and the conversional mechanical watch, which has a novel visual effect.

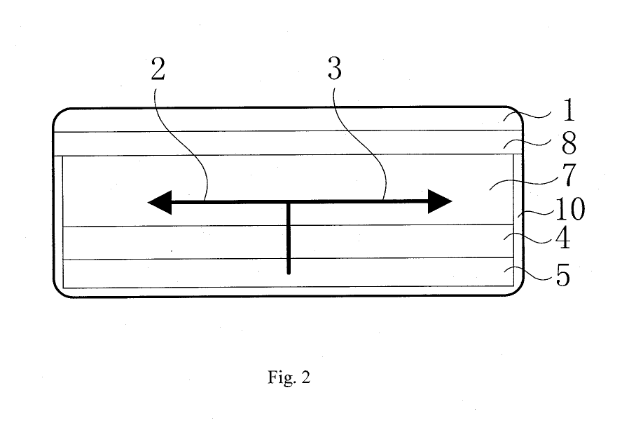

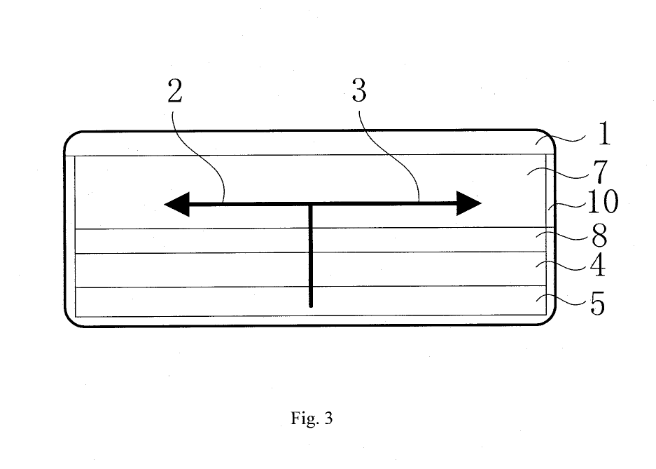

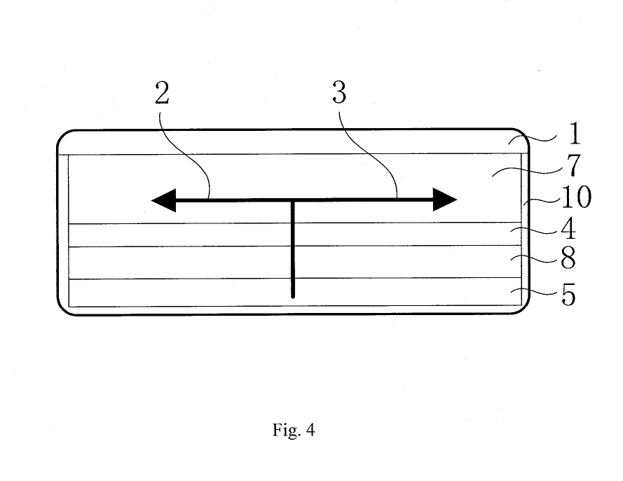

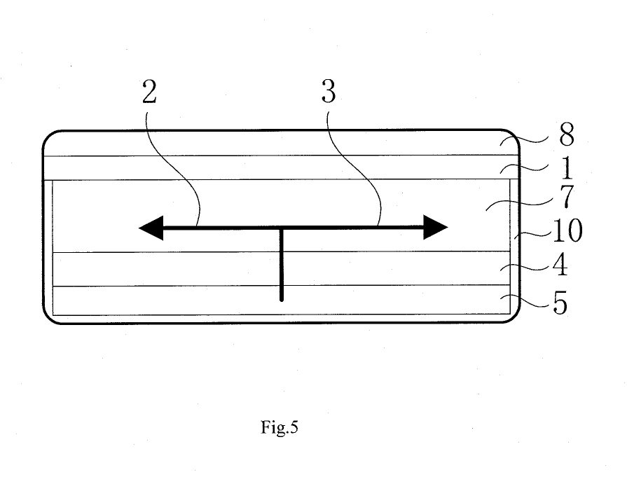

In the present disclosure, the transparent solar element 8 is provided in the inner cavity 7 and above the movement layer 5. The transparent solar element 8 is coupled to a battery of the analogue smart watch, to collect solar power and charge the battery of the watch during daily use. The transparent solar element 8 may be a thin film solar cell. As illustrated in FIG. 2, the transparent solar element 8 of the present disclosure may be provided on the lower surface of the cover 1. Alternatively, as illustrated in FIG. 3, the transparent solar element 8 of the present disclosure may be provided on the top surface of the transparent display element 4. Alternatively, as illustrated in FIG. 4, the transparent solar element 8 of the present disclosure may be provided between the transparent display element 4 and the movement layer 5. The transparent solar element 8 in FIGS. 3 and 4 also has an axis hole through which the rotation axis of the hour hand 2 and the minute hand 3 passes. Changing the position of the transparent solar element 8 or providing transparent solar elements 8 respectively on different positions based on the present disclosure also falls within the protection scope of the present disclosure. For example, as illustrated in FIG. 5, the transparent solar element 8 of the present disclosure may be provided on the upper surface of the cover 1.

The control module of the present disclosure may be provided in the movement layer 5. Alternatively, the control module is provided outside the inner cavity 7 and controls the analogue smart watch by means of NFC or Bluetooth.

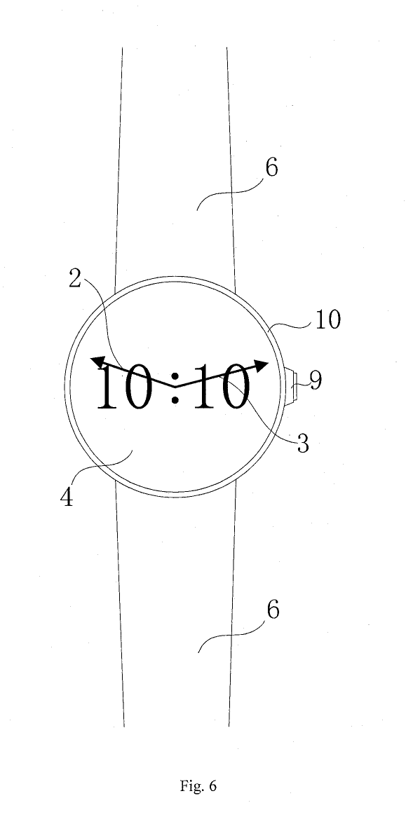

The display method using the analogue smart watch of the present disclosure includes: triggering the control module to control the switch of the transparent display element 4 between the display state in which an image is displayed and the transparent state in which no image is displayed. When the transparent display element 4 is in the transparent state, the transparent display element 4 has a transmittance equal to or greater than 90%. The movement layer 5 is visible through the cover 1 and the transparent display element 4. The user may visually see the beautiful movement layer 5. As illustrated in FIGS. 6, 7 and 8, the user may active the transparent display element 4 by means of simply pressing the crown 9, thereby displaying a content at the central position of the transparent display element 4, and accepting the touch operation of the user on the cover 1, so as to operate and interact with the content displayed by the transparent display element 4. The content displayed by the transparent display element 4 may be time, weather, short message, and so on, but it is not limited thereto. In addition, it can be ensured that while the user is checking and operating the displayed content, the inside movement layer is still visible through the transparent display element 4. The present disclosure combines a visual effect of a mechanic part and a visual effect of an electronic display together (as serving the movement layer 5 as a background and displaying the electronic content on the background).

### The Second Embodiment

Since the present disclosure is a product combining a touch type electronic watch and a conventional mechanic watch, there is a visual defect in the first embodiment that while displaying content, the transparent display element 4 is usually shielded by the hour hand 2 and the minute hand 3. Accordingly, people cannot clearly see the content to be displayed, and thus it is inconvenient for the user to read the displayed content comfortably, thereby deteriorating humanity experience. The second embodiment partitions the display region of the transparent display element 4 on the basis of the first embodiment, to avoid the hour hand 2 and the minute hand 3, so that people will see the content to be displayed more clearly.

The second embodiment adds a display region adjusting module on the basis of the first embodiment, to take the portions of the transparent display element 4 that are not shielded by the hour hand 2 and the minute hand 3 as at least one display region, according to the positions of the hour hand 2 and the minute hand 3. The display region adjusting module may be integrated in the control module, or the function of the display region adjusting module may be performed by the control module.

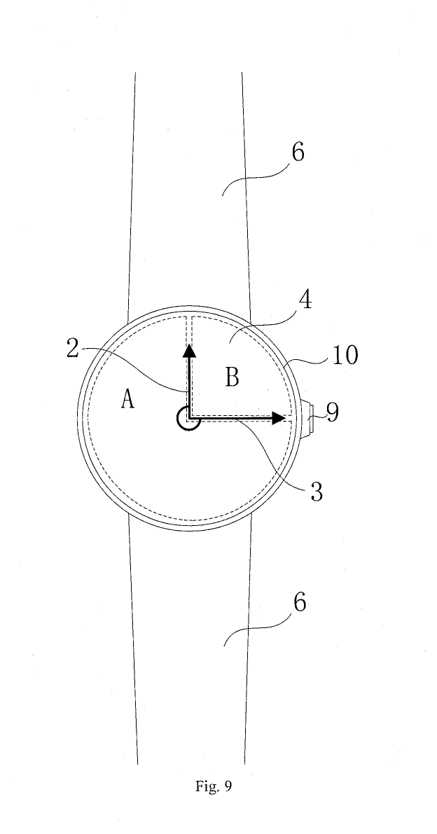

In the second embodiment, a step of partitioning the display region is further added on the basis of the display method of the first embodiment. As illustrated in FIG. 9, the positions of the hour hand 2 and the minute hand 3 partition the transparent display element 4 into a first region A and a second region B.

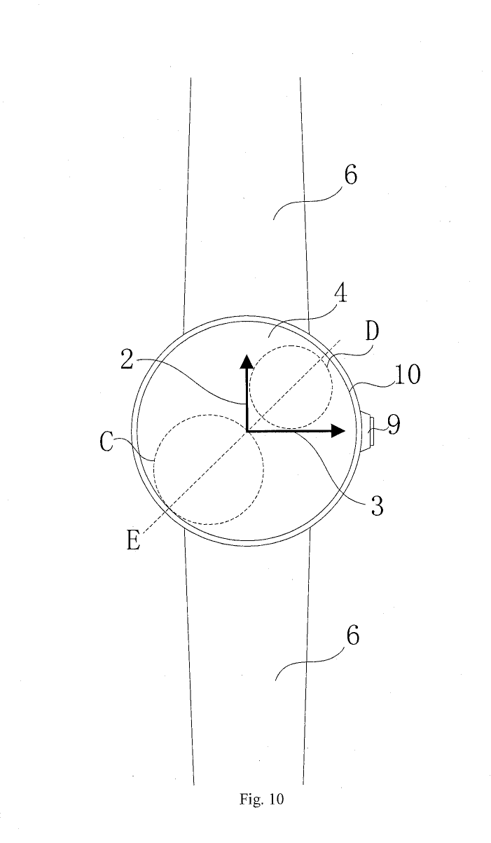

As illustrated in FIG. 10, the display region adjusting module locates more proper first display region C and second display region D in the first region A and the second region B, respectively. That is, the display region adjusting module further optimizes the location and area of the display region that displays the image content. The first display region C corresponds to a first angle between the hour hand 2 and the minute hand 3, the second display are D corresponds to a second angle between the hour hand 2 and the minute hand 3, and the first angle is equal to or greater than the second angle. A center of the first display region C is positioned along the bisector E of the first angle, and a center of the second display region D is positioned along the bisector E of the second angle. Therefore, the first display region C and the second display region D may obtain a display region as large as possible based on the positions of the hour hand 2 and the minute hand 3.

The case of the analogue smart watch may be one of circular shape, triangular shape, rhombus shape, hexagonal shape or rectangular shape, but it is not limited thereto. The first display region C may also be configured as one of circular shape, triangular shape, rhombus shape, hexagonal shape or rectangular shape, but it is not limited thereto. The second display region D may also be configured as one of circular shape, triangular shape, rhombus shape, hexagonal shape or rectangular shape, but it is not limited thereto. When both of the first display region C and the second display region D are configured as circular shape, both of the diameters of the first display region C and the second display region D are equal to or smaller than the distance between the axis hole and an inner wall of the case 10, but it is not limited thereto. When both of the first display region C and the second display region D are configured as rectangular shape, both of the diagonal lines of the first display region C and the second display region D are equal to or smaller than the distance between the axis hole and the inner wall of the case 10, but it is not limited thereto.

For example, the display region adjusting module may successively calculate, according to the time of the control module of the analogue smart watch, the positions of the hour hand 2 and minute hand 3, the position of the bisector E of the first angle and the position of the bisector E of the second angle, the diameter of the first display region C and the diameter of the second display region D, the position of the center of the first display region C and the position of the center of the second display region D, and the like, thereby forming the accurate regions of the first display region C and the second display region D on the transparent display element 4. In addition, the control module may zoom out and optimize the content to be displayed according to the actual areas of the first display region C and the second display region D, so as to achieve a better visual effect.

In an alternate embodiment, when display regions are partitioned in the transparent display element 4, portions of the cover 1 corresponding to the display regions may perform touch sensing, and other portions of the cover 1 terminate touch sensing so as to enhance the correspondence between the cover 1 and the transparent display element 4 and prevent the user's false operation. In the present disclosure, the portions of the cover 1 corresponding to the display regions substantially refer to the portions in the cover 1 that are positioned vertically over the display regions.

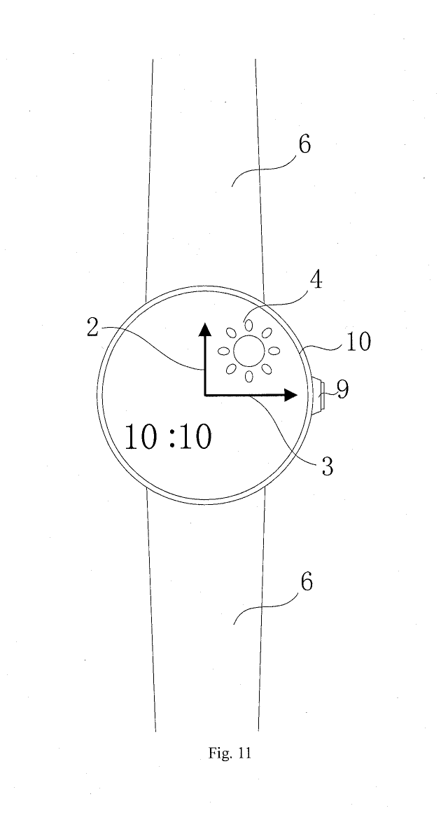

The user may trigger the control module by operating the crown of the analogue smart watch, to control the switch of the transparent display element 4 between the display state and the transparent state. For example, as illustrated in FIG. 11, the user may activate the transparent display element 4 by means of simply pressing the crown 9, thereby respectively displaying different contents in the first display region C and the second display region D of the transparent display element 4, e.g., displaying time information in the first display region C, and displaying weather information in the second display region D, so that the user may simultaneously operate and receive various information contents. In addition, compared with the first embodiment, the technical solution of the second embodiment may completely prevent the displayed content from being shielded and disturbed by the hour hand 2 and the minute hand 3.

### The Third Embodiment

On the basis of the display method of the second embodiment, the third embodiment further compares the areas of the first display region and the second display region, thereby choosing an optimized display region.

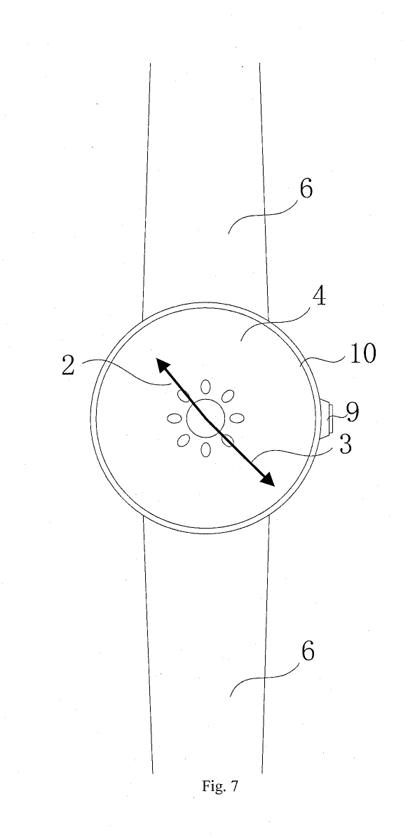

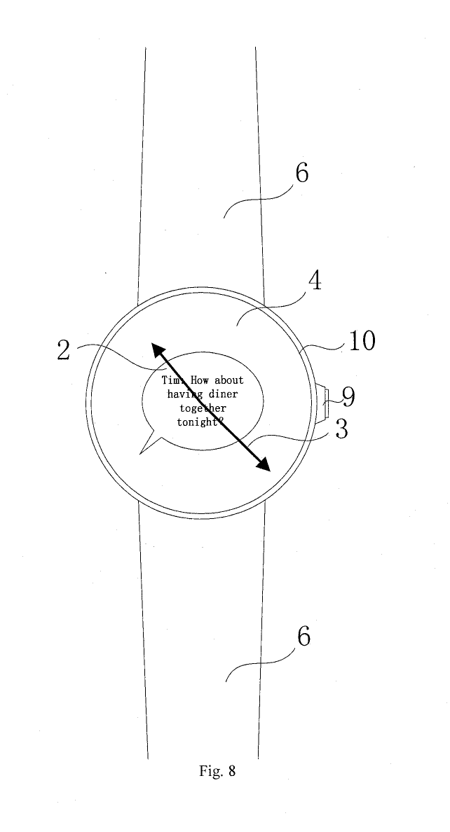

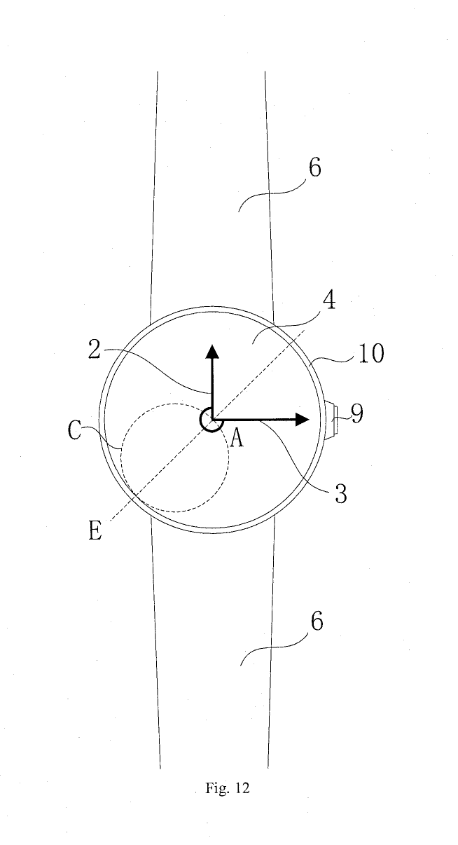

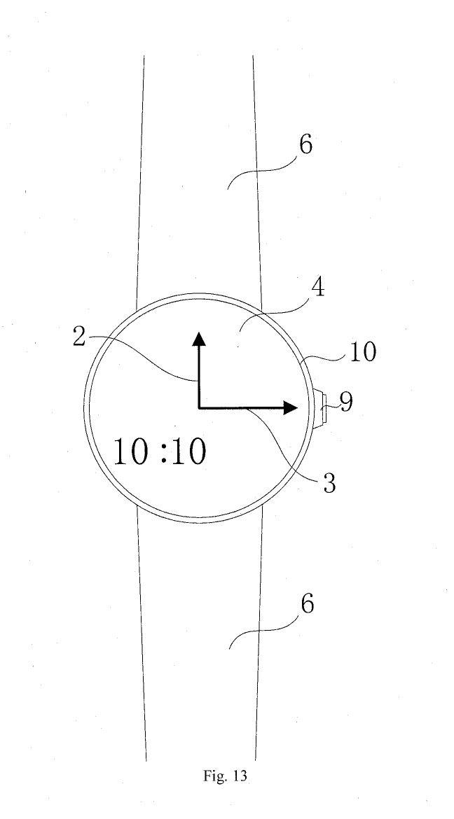

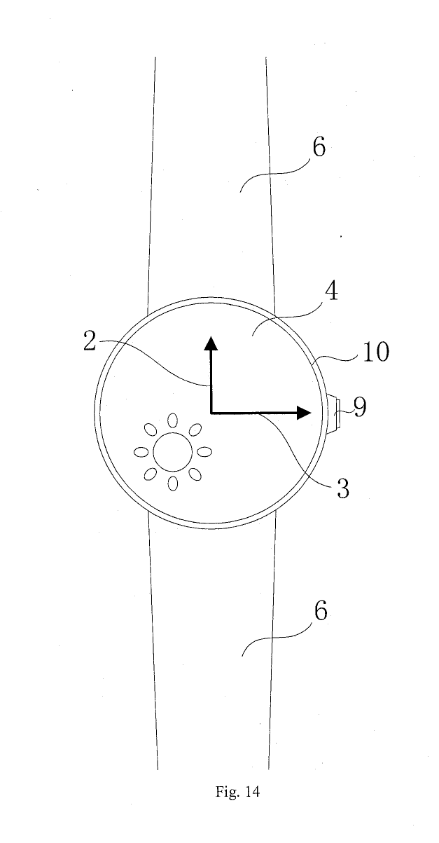

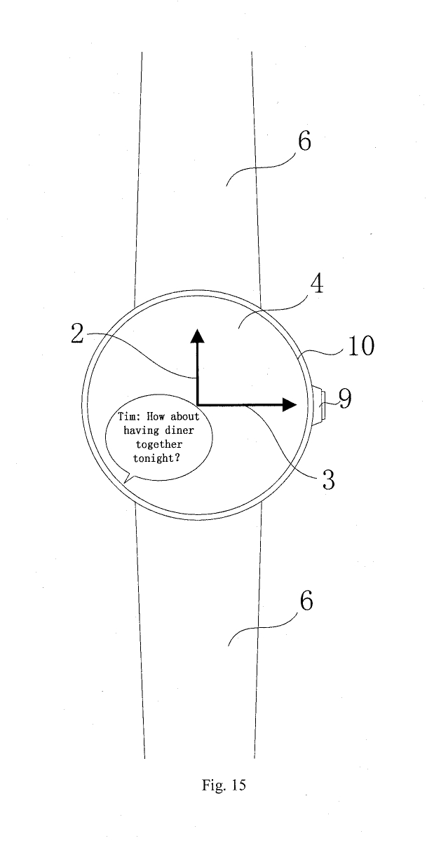

As illustrated in FIG. 12, a display region (the first display region C) having a larger area for displaying and a display region (the second display region D, not illustrated in FIG. 12, refer to FIG. 10) having a smaller area that always maintains transparent are provided by the control module. Obviously, displaying in the first display region C may have a better visual effect than displaying in the second display region D (not illustrated in FIG. 12, refer to FIG. 10). As illustrated in FIGS. 13, 14 and 15, in the display states of the third embodiments, the analogue smart watch of the present disclosure not only partitions the display regions, but also selects a display region having the best visual effect (i.e., having the largest display area) for displaying information. By visually comparing FIG. 13 with FIG. 6 of the first embodiment, FIG. 14 with FIG. 7 of the first embodiment, and FIG. 15 with FIG. 8 of the first embodiment, it can be seen that compared with the first embodiment, the third embodiment may have a purer visual effect and avoid visual disturbance of the watch hands.

By visually comparing FIGS. 13, 14 and 15 with FIG. 11 of the second embodiment, it can be seen that compared with the second embodiment, the third embodiment may simplify information provided to the user, avoid disturbance to the user due to too many information, and always provide information to the user at the best display region of the transparent display element 4. Repeated description thereof will be omitted herein.

Particular embodiments of the present disclosure have been described above. It should understood that the present disclosure is not limited to the above particular implementations, and those skilled in the art may make various changes or modifications within the scope of the claims, all without affecting the substantive content of the present disclosure.

What is claimed is:

1. A pointer-type smart watch, comprising:
a cover, comprising a touch sensing unit;
a case, collectively forming an inner cavity with the cover, and an hour hand and a minute hand being rotatable inside the inner cavity;
a movement layer, provided at the bottom of the case, connected to the hour hand and the minute hand with a rotation axis to provide power for rotation of the hour hand and the minute hand in the inner cavity;
a transparent display element, provided in the inner cavity and above the movement layer, wherein the transparent display element comprises an axis hole, and the rotation axis passes through the axis hole;
a control module, configured to control operating states of the transparent display element; and
a transparent solar element, provided in the inner cavity and above the movement layer, and coupled to a battery of the pointer-type smart watch.

2. The pointer-type smart watch according to claim 1, wherein the operating states of the transparent display element comprise a display state and a transparent state, and when the transparent display element is in the transparent state, the movement layer is visible through the cover and the transparent display element.

3. The pointer-type smart watch according to claim 2, wherein when the transparent display element is in the transparent state, the transparent display element has a transmittance equal to or greater than 90%.

4. The pointer-type smart watch according to claim 1, wherein the transparent display element is a liquid crystal display device or an organic electroluminescence display device.

5. The pointer-type smart watch according to claim 1, wherein the control module is provided in the movement layer.

6. The pointer-type smart watch according to claim 1, wherein the control module is provided outside the inner cavity.

7. The pointer-type smart watch according to claim 1, further comprising a physical button, configured to trigger the control module to control the operating states of the transparent display element.

8. The pointer-type smart watch according to claim 7, wherein the physical button is a crown.

9. The pointer-type smart watch according to claim 1, wherein the transparent solar element is provided at one of the following positions: between the transparent display element and the movement layer, on the upper surface of the transparent display device, on the lower surface of the cover, and on the upper surface of the cover.

10. The pointer-type smart watch according to claim 1, further comprising a display region adjusting module configured to take portions of the transparent display element that are not shielded by the hour hand and the minute hand as at least one display region, according to positions of the hour hand and the minute hand.

11. The pointer-type smart watch according to claim 10, wherein the positions of the hour hand and the minute hand partition the transparent display element into a first display region corresponding to a first angle between the hour hand and the minute hand and a second display region corresponding to a second angle between the hour hand and the minute hand, wherein the first angle is equal to or greater than the second angle.

12. The pointer-type smart watch according to claim 11, wherein each of the case, the first display region and the second display region has one of circular shape, triangular shape, rhombus shape, hexagonal shape or rectangular shape.

13. The pointer-type smart watch according to claim 10, wherein portions of the cover over the display region and corresponding to the display region perform touch sensing and other portions of the cover terminate touch sensing.

14. A method for displaying of a pointer-type smart watch having a movement layer, a transparent display element, a control module and a transparent solar element collectively configured inside a cavity of a case with a cover, the method comprising:
switching operation states of the pointer-type smart watch between a display state and a transparent state; wherein when the pointer-type smart watch is switched to the transparent state, the movement layer of the pointer-type smart watch is visible through the cover and the transparent display element.

15. The method for displaying of the pointer-type smart watch according to claim 14, wherein when the pointer-type smart watch is in the transparent state, the transparent display element has a transmittance equal to or greater than 90%.

16. The method for displaying of the pointer-type smart watch according to claim 14, further comprising
when the pointer-type smart watch is in the display state, taking portions of the transparent display element that are not shielded by an hour hand and a minute hand of the pointer-type smart watch as at least one display region, according to positions of the hour hand and the minute hand.

17. The method for displaying of the pointer-type smart watch according to claim 16, wherein the positions of the hour hand and the minute hand partition the transparent display element into a first display region corresponding to a first angle between the hour hand and the minute hand and a second display region corresponding to a second angle between the hour hand and the minute hand, wherein the first angle is equal to or greater than the second angle.

18. The method for displaying of the pointer-type smart watch according to claim 17, wherein a center of the first display region is positioned along the bisector of the first angle, and a center of the second display region is positioned along the bisector of the second angle.

19. The method for displaying of the pointer-type smart watch according to claim 17, wherein:
when the first display region and the second display region are configured as a circular shape, both a diameter of the first display region and a diameter of the second display region are equal to or smaller than the distance from the axis hole to an inner wall of the case.

20. The method for displaying of the pointer-type smart watch according to claim 17, wherein:
when the first display region and the second display region are configured as a rectangular shape, both a diagonal of the first display region and a diagonal of the second display region are equal to or smaller than the distance from the axis hole to an inner wall of the case.

21. The method for displaying of the pointer-type smart watch according to claim 17, further comprising:
comparing areas of the first display region and the second display region, and displaying region having a larger area and maintaining the display region having a smaller area the transparent state.

22. The method for displaying of the pointer-type smart watch according to claim 16, further comprising:
performing touch sensing on portions of the cover over the display region and corresponding to the display region and terminating touch sensing on other portions of the cover.

23. The method for displaying of the pointer-type smart watch according to claim 14, further comprising:
triggering the control module to control the transparent display element switch between the transparent state and the display state by operating a crown of the pointer-type smart watch.
